(19) United States
(12) Patent Application Publication
(10) Pub. No.: US 2012/0312949 A1
(43) Pub. Date: Dec. 13, 2012

(54) Barn Spike

(76) Inventor: Wilbur Tuttle, Bellaire, MI (US)

(21) Appl. No.: 13/154,518

(22) Filed: Jun. 7, 2011

(51) Int. Cl. F16M 13/00

(52) U.S. Cl. 248/311.2

(57) ABSTRACT

A spike for supporting a receptacle has an virgate shank and an integrally formed spherical head. The spherical head retains the receptacle on the shank, and the spherical head has a surface area to exceed a puncture pressure of skin. When the spherical head is driven, a tapered end of the shank penetrates a support.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Exemplary embodiments generally relate to supports, receptacle supports, brackets, fasteners, hat/shoe racks, and husbandry. Exemplary embodiments more particularly relate to hooks, hangers, nails with penetrating means, wall anchors, heads, impact-driven supports, driving heads, domed heads, and bucket supports.

Conventional nails, spikes, and other fasteners are dangerous to animals and to people. These conventional fasteners have a sharp-edged head or other surface. A conventional nail, for example, has a head with a sharp edge. Horses, cattle, and other prized livestock are often injured by these sharp-edged fasteners. Clothing and gear are also ripped and torn by these sharp-edged fasteners.

### BRIEF DESCRIPTION OF THE SEVERAL VIEWS OF THE DRAWINGS

The features, aspects, and advantages of the exemplary embodiments are better understood when the following Detailed Description is read with reference to the accompanying drawings, wherein:

FIG. 1 is a schematic illustrating a barn spike, according to exemplary embodiments;

FIGS. 2-4 are schematic illustrating orthographic views of the barn spike, according to exemplary embodiments;

FIG. 5 is a schematic illustrating an orthographic side view of the barn spike, according to exemplary embodiments; and

FIG. 6 is another schematic illustrating the orthographic side view of the barn spike, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. Those of ordinary skill in the art further understand that the exemplary embodiments described herein are for illustrative purposes and, thus, are not intended to be limited.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features and/or components, but do not preclude the presence or addition of one or more other features, elements, components, and/or groups thereof. As used herein, the term “and/or” includes any and all combinations of one or more of the associated listed items.

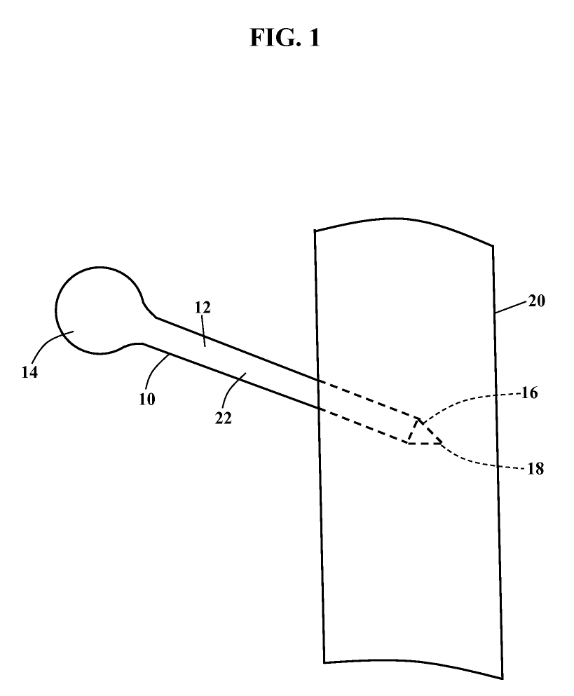

FIG. 1 is a schematic illustrating a barn spike 10, according to exemplary embodiments. The barn spike 10 has a virgate shank 12 with a spherical head 14. The shank 12 and the spherical head 14 are integrally formed from a single piece of material. The shank 12 and the spherical head 14, for example, may be turned on a metal lathe from a single block of carbon steel. The shank 12 has an opposite end 16 that tapers to a point 18. The barn spike 10 is driven into a support 20 by striking the spherical head 14, and the point 18 of the taped end 16 penetrates the support 20. Receptacles, clothing, and other items may then be hung from the barn spike 10, and the spherical head 14 helps prevent the articles from slipping off the shank 12. The barn spike 10 may include a coating 22, such as a colored anodized coating or a sacrificial coating (e.g., galvanizing).

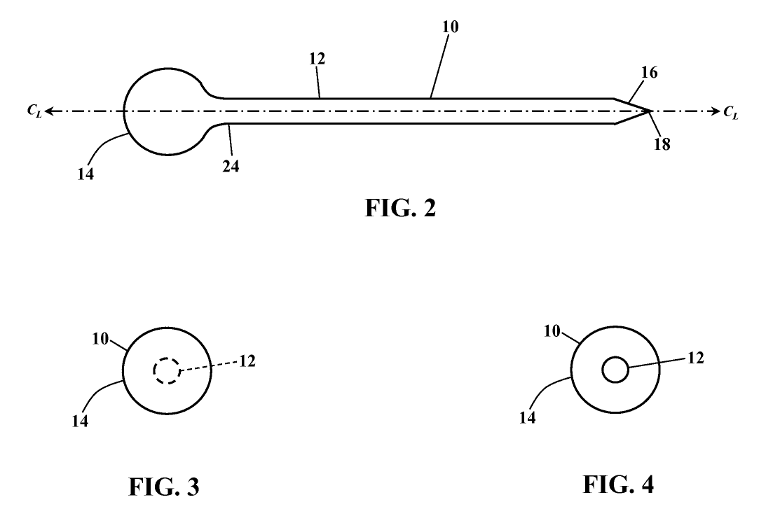

FIGS. 2-4 are schematics illustrating orthographic views of the barn spike 10, according to exemplary embodiments. FIG. 2 is a side view, while FIGS. 3-4 are opposite end views. The virgate shank 12 has the spherical head 14 at an end 24, and the opposite end 16 of the shank 12 tapers to the point 18.

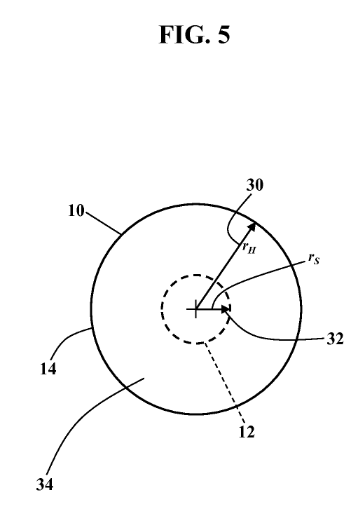

FIG. 5 is a schematic illustrating an orthographic side view of the barn spike 10, according to exemplary embodiments. Here the spherical head 14 is shown enlarged for clarity of features. The spherical head 14 is sized to reduce the possibility of laceration and skin puncture in humans and in animals. The spherical head 14 has a radius r_{H} (illustrated as reference numeral 30) that is at least three times (3×) a radius r_{S} (illustrated as reference numeral 32) of the shank 12. The radius r_{H} is also selected such that the spherical head 14 has a surface area S_{H} (illustrated as reference numeral 34) that reduces occurrence of laceration and skin puncture. Tests have shown that human skin punctures when an 18-gauge (1.27 mm) needle is inserted with an approximately six Newton (6.027 N) force. The area of the needle, using πr², is (3.1416)×(1.27/2)²=1.267 mm². The puncture pressure may thus be calculated as

$$\frac{6.027}{1.267} = 4.76 N \text{/} {mm}^{2} .$$

If the radius r_{H} of the spherical head 14 is five millimeters (5.0 mm), for example, then the surface area of the spherical head 14 will require approximately five times (5×) the puncture force before the spherical head 14 will puncture human skin. The spherical head 14 is thus much safer for humans and for animals. Moreover, the larger spherical head 14 has less tendency to tear or rip clothing that is hung from the barn spike 10.

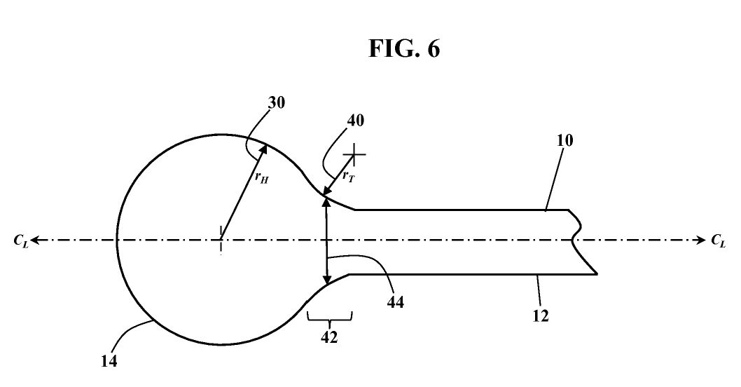

FIG. 6 is another schematic illustrating the orthographic side view of the barn spike 10, according to exemplary embodiments. Here again the spherical head 14 is enlarged for clarity of features. Because the shank 12 and the spherical head 14 may be integrally formed from a single piece of material, the spherical head 14 transitions to the shank 12. The spherical head 14 has the concave radius r_{H} (illustrated as reference numeral 30), and a convex radius r_{T} (illustrated as reference numeral 40) blends the spherical head 14 to the shank 12. The convex radius r_{T} produces a transition zone 42 having a diameter 44 greater than the shank 12 (e.g., the radius r_{S} illustrated as reference numeral 32 in FIGS. 3-5). The transition zone 42 thus provides added material to avoid an abrupt transition from the spherical head 14 to the shank 12.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A spike for supporting a receptacle, comprising:
a virgate shank having a spherical head at one end and a taper at an opposite end of the shank, the virgate shank and the spherical head integrally formed from a single piece of material, wherein the taper penetrates a support when the spherical head is driven, and wherein the spherical head retains the receptacle on the shank.

2. The spike according to claim 1, wherein the spherical head has a surface area sized to exceed a puncture pressure of skin when force is applied to the spherical head.

3. The spike according to claim 1, further comprising an anodized coating on the shank.

4. The spike according to claim 1, further comprising a sacrificial coating on the shank.

5. A spike for supporting a receptacle, comprising:
a virgate shank having a completely spherical head at one end and a taper at an opposite end of the shank, the shank and the spherical head integrally formed from a single piece of material, the spherical head having both a concave radius and a convex radius blending the spherical head to the shank, the convex radius producing a transition zone having a diameter greater than the shank, the spherical head having a surface area sized to exceed a puncture pressure of skin when force is applied to the spherical head,
wherein the taper penetrates a support when the spherical head is driven, and the spherical head retains the receptacle on the shank.

6. The spike according to claim 5, further comprising an anodized coating on the shank.

7. The spike according to claim 5, further comprising a sacrificial coating on the shank.
